(19) United States
(12) Patent Application Publication
(10) Pub. No.: US 2009/0013375 A1
(43) Pub. Date: Jan. 8, 2009

(54) PERMISSIONS MANAGEMENT PLATFORM

(76) Inventors: Paul MacIntosh, Woodstock, NH (US); Russell Grin, Los Angeles, CA (US); Haffner Crosby, Los Angeles, CA (US)

Correspondence Address: BUCHALTER NEMER, 18400 VON KARMAN AVE., SUITE 800, IRVINE, CA, 92612, US

(21) Appl. No.: 12/166,731

(22) Filed: Jul. 2, 2008

Related U.S. Application Data
(60) Provisional application No. 60/947,451, filed on Jul. 2, 2007.

(51) Int. Cl. H04L 9/32

(52) U.S. Cl. 726/1

(57) ABSTRACT

A permissions management platform is disclosed that includes: a documentation agent, which documents at least one circumstance, wherein the at least one circumstance comprises at least one permission that is provided from at least one first party to at least one second party, and at least one authorized party, wherein the at least one party has access to the documentation agent. A software system is also disclosed that includes the permissions management platform disclosed herein stored on a recordable medium. Methods for documenting and managing permissions information are described that include: providing a documentation agent that documents the circumstances in which permission is provided from at least one first party to at least one second party; creating a documentation record; storing the documentation record in a retrievable format, and providing at least one authorized party having access to the documentation record.

This Utility application claims priority to U.S. Provisional Application Ser. No. 60/947,451, filed on Jul. 2, 2007, which is incorporated herein in its entirety by reference.

### BACKGROUND

Many of the methods utilized to control unwanted electronic messaging (SPAM) are inferred, passive, and reactive. Message content is analyzed and inferences are made on keywords, URL links, images, sender, source IP, etc. Messages inferred to be SPAM may be blocked, accepted and discarded, or accepted and placed in a SPAM folder. For conventional electronic mail or “email” messaging, at the Messaging Transfer Agent (MTA) level, Consumer email providers (CEPs) will place constraints on how email is accepted, filter messaging based on source IP, and utilize other profiling techniques to identify SPAM.

CEPs profile source IP addresses and sender domains and subscribe to blacklists maintained by third parties. CEPs will also run whitelisting programs to “certify” senders of electronic messaging that register with them and maintain certain messaging quality thresholds. Despite all these activities overall messaging quality is still poor with up to 80% of all email being unwanted.

Delivery of email messaging is typically predicated on a number of criteria. The recipient MTA must have resources available to handle the volume of email delivery. The sending MTA must adhere to various limitations such as: maximum number of simultaneous connections, maximum number of emails per connection, maximum number of emails per hour/day, etc. All these foregoing criteria may be on a per-IP address basis, although CEPs may profile ranges of IP space (typically on a /24 basis) based on activity from just a few IPs. Bulk mail MTAs are typically designed to adhere to the specific limitations of the CEPs, each of which may have different settings. In addition to standard throttling limits, some CEPs may automatically defer the first connection request from any IP, waiting until the connection is retried to accept it. These CEPs may initially defer all senders under the theory that legitimate email is more likely to be retried by its MTA than SPAM or other bulk electronic mail. In general, throttling settings are designed to reduce the amount of unwanted mail a CEP must process.

In addition to these throttling settings, CEPs perform various authentication checks on the inbound email—reverse DNS, SPF and DKIM are all designed to ensure that, at a minimum, the IP address and sending domain are valid and have not been illegally falsified by a malicious third party. Once email has passed all these tests, it is subjected to filtering based on IP, body content, links etc.

As email is delivered, two additional metrics become known by the CEP the number of valid addresses and the number of “spam” complaints by their customers. For example, in order to qualify for some whitelisting programs (which may result in the removal of the sending limitations normally applied to inbound mail) a sender must have mail traffic where more than 90% of messages are valid addresses (i.e., they don't bounce back) and there are fewer than 3000 “spam” complaints per million messages sent. This “bounce ratio” and “complaint ratio” are the two primary objective criteria the CEPs have to measure the quality of the email they receive. Many CEPs run whitelisting programs, and some incorporate manual processes such as human review of the sender's website, as part of the approval process. Practically, ongoing qualification for a whitelisting program is based on the bounce and complaint rates because these can be automatically measured. Whitelisting programs are designed to allow legitimate senders of bulk mail to get their mail delivered more easily, and enable the CEP to develop an ongoing reputation for the sender based on bounce and complaint ratios and mail volume.

Even if a CEP accepts mail through a whitelisting program, this typically does not guarantee inbox delivery. On the contrary, all email may automatically be placed in the bulk folder to begin with, until a reputation has been established. The whitelisting program simply guarantees delivery of the mail—in other words, the MTA connection isn't refused or deferred, and the mail isn't simply thrown away.

As part of supporting whitelisting programs, a CEP will typically provide a feedback loop (FBL) to the sender. The FBL notifies the sender when an address is invalid, and when a recipient marked a piece of mail as “spam”. This information is shared with the sender to communicate how well the sender is adhering to the whitelist policy, and may be utilized by the sender to decide which recipients should not receive additional mail in the future. Notably, FBL data is not generally used by CEP pro-actively block email for a particular recipient. Rather, CEPs passively rely on the sender to use FBL data to maintain the quality standards required by the whitelisting program, which may or may not include automatically unsubscribing recipients who marked a piece of mail as “spam”.

One can assume that CEPs are trying to achieve two related but different objectives. The first is to reduce the amount of mail their MTA infrastructure must process. Many of the largest CEPs, for example, state that 80% of the billions of messages they receive each day are unwanted messages, going into the bulk folder or simply thrown away. The second is to keep their customers happy by preventing the delivery of excessive amounts of SPAM, and also minimizing “false positive” classification of a legitimate message as SPAM. A primary indicator of dissatisfaction is the “this is spam” button made available to CEP customers. Of particular note is that the CEP does not have access to the most critical information about whether a piece of mail is wanted or not—the CEP doesn't know if the mail is part of a business transaction, if the consumer requested the mail, if the sender is malicious, etc. The CEP does not have access to any of the directly relevant information about whether mail is wanted or not, and as a result expends a lot of resources and effort trying to infer messaging relevance through filtering based on sender profiling, message profiling, and reducing inbound mail volume through sending limitations. Inherent in each of these tactics and methods is that messaging is dealt with in bulk based on statistics, rather than on the characteristics of an individual message.

These problems are complicated by the sending practices of the largest, most reputable bulk senders (Publishers) which are, by definition, handing large amounts of mail. When mail is queued for sending in an MTA, it's typically an irreversible event—a particular email message cannot be retracted without terminating the entire queue. A sender may have a queue of mail that is millions of messages, and there may be multiple messages for the same user (e.g. bob@aol.com may have a half dozen messages addressed to him in a single queue). If bob@aol.com hits the “this is spam” button, and the CEP immediately tells the sender this via an FBL, bob@aol.com will still receive all half dozen messages (even if the Publisher processes the FBL info immediately, which most Publishers do not) because those messages have already been queued for sending. In this way, a single “spam” complaint may turn into a half dozen “spam” complaints, making everyone unhappy—the CEP, the sender and Bob.

Complicating matters further, most Publishers do not process their own FBL information, and also do not directly handle recipient unsubscribe requests. Instead, the process typically works as follows. When an Advertiser starts doing business with a Publisher, the Advertiser provides the Publisher with two things—a subscribe list, and a suppression list. The subscribe list contains information on all the consumers who issued the Advertiser permission (opted in) to send advertising content. The suppression list is a list of all the consumers who are on the subscribe list who should not be sent any mail, because they opted out, complained, are an invalid address, etc. Each day, the Advertiser will deliver amendments to the subscribe list and the suppression list to each of its Publishers. The subscribe and suppression lists are kept separate for a variety of reasons, among them the maintenance of an audit trail for how/when a consumer opted in and opted out of a particular list. In addition, each Publisher will receive complaints based on its particular mailing activity. In best practices, Publishers deliver this information to the Advertiser, who adds the information to the suppression file, and distributes it to each Publisher—in this way, a user who complains to Publisher A should end up on the suppression file of Publishers B and C who are also doing business with the Advertiser.

By definition, a Publisher must handle consumer complaints which are based on email originating from that Publisher. Whether or not a particular Publisher delivers this information to the Advertiser, and whether the Advertiser incorporates this into the suppression file and successfully distributes this to all its Publishers is dependent on the operational quality of the parties involved. Unsubscribe requests, which follow a pattern which is better-defined than complaints, are typically left to the Advertiser. The reason for this is that unsubscribe handling is mandated under the CAN-SPAM Act, and is generally understood to be the responsibility of the Advertiser. Publishers do not want to take on more responsibility than required, and do not want to expose themselves to the potential liability of handling a legislative compliance requirement.

All of this results in sending scenarios which are heavily dependent on the operational quality of all the involved parties (and therefore fragile, vulnerable to any party's operational problems) and a built-in time delay for suppression file processing, which is acknowledged in the CAN SPAM Act requiring only that unsubscribe requests be processed within 10 days. This means that if a consumer unsubscribes from a list which is delivered daily, that consumer may receive 10 more messages before the sending stops. The consumer may complain 10 more times, be unhappy, make his CEP unhappy, etc., all in the context of an unsubscribe process which is within legislative compliance. In addition, as a result of these practices recipient addresses are exposed at multiple points to the risk of theft and abuse, with virtually no ability for the Advertiser or any other party to determine who was responsible for such misuse. As a result, many consumers receive SPAM as a result of their email address information falling into the possession of unscrupulous third parties.

In the context of all the data exchanges which occur between Advertisers and their Publishers, of note is the fact that whitelisting programs themselves (and the associated FBLs) are both reactive and passive. They are reactive in that they only report problems after they occur (e.g. this message attempted is an invalid address; this message delivered resulted in a consumer complaint). They are passive in that they rely on the Publisher to do something with the FBL information—a whitelisting program does not prevent a Publisher from repeatedly sending email to bob@aol.com who has said he considers the mail spam, because the CEP merely reports the information via FBL and relies on the Publisher to do something about it. The enforcement action typically available to a whitelisting program is termination of whitelisting status based on non-adherence to the bounce/complaint ratios. In theory, this means that a Publisher could continue sending to bob@aol.com, who continues to mark the messages as spam, forever so long as the Publisher's overall complaint ratio is within the whitelisting program's guidelines.

In the environment of email marketing, which comprises the majority of legitimate bulk email messaging, the relationship between a sender and a receiver typically begins when a consumer authorizes an Advertiser to deliver certain types of messaging. In the current art, “opt-in” information is captured by Advertisers for the purpose of creating a record of the request, which typically includes the name of the website, the IP address of the consumer, the email address of the consumer, the date and time, and any information (such as name, gender or other demographic information) the consumer submitted to the Advertiser. This opt-in information is generally kept by the Advertiser, may be distributed to Publishers using such data in some circumstances, and referenced primarily for the purpose of complaint handling and opt-in verification to a third party when necessary. However, the broader circumstances by which such permission was issued by the consumer are important, as the representations and disclosures made by the Advertiser to induce the consumer to issue such permission are a material part of the permission itself. For example, those skilled in the art of consumer protection laws and enforcement are familiar with the importance of the circumstances and context of any consumer action, in order to protect against inadequate disclosure, misleading representations, or deceptive business practices by Advertisers. In addition, because opt-in information is collected and stored by the Advertiser, is available only in exceptional circumstances and upon request, and because opt-in information is typically limited in scope, its authenticity may be questioned by third parties seeking to determine whether such opt-in event actually occurred.

Problems exist at a fairly fundamental level across messaging systems operating based on inference. Ideally, electronic messaging systems could incorporate information pertaining to the relationship between the sender and receiver, which ultimately represents the basis for any messaging between such parties. In an ideal environment, a consumer or other authorized party would be able to recover the specific permission which resulted in the delivery of any particular message. In addition, in an ideal environment the consumer or party which provided a permission would have the ability to modify the terms of, or revoke entirely, such previously granted permission.

A Permissions Management Platform (PMP) which tracks and exposes the origination, circumstances and history of permissions between parties would be an ideal solution and would provide substantial utility to consumers and CEPs. By exposing the activities and relationships which result in messaging to its customers, a PMP provides CEPs with the information most relevant for determining whether any particular message is wanted by the recipient or will be considered SPAM. CEPs would be able to determine the appropriate handling of a message based on the specific message, rather than inferred information derived from profiling, bounce and complaint ratios, and other statistical methods. A PMP also provides CEPs with additional information by which to measure the legitimacy and quality of messaging, which may be incorporated into its profiling methods, filtering activities, and whitelisting programs. Finally, a PMP provides CEPs with additional tools, beyond a “this is spam” button, by which to empower its users and increase customer satisfaction.

### SUMMARY

A permissions management platform is disclosed that includes: a documentation agent, which documents at least one circumstance, wherein the at least one circumstance comprises at least one permission that is provided from at least one first party to at least one second party, and at least one authorized party, wherein the at least one party has access to the documentation agent. A software system is also disclosed that includes the permissions management platform disclosed herein stored on a recordable medium. Methods for documenting and managing permissions information are described that include: providing a documentation agent that documents the circumstances in which permission is provided from at least one first party to at least one second party; creating a documentation record; storing the documentation record in a retrievable format; and providing at least one authorized party having access to the documentation record.

### BRIEF DESCRIPTION OF THE FIGURES

FIG. 1 is a schematic of an example system that manages permissions records and provides such records to various users.

FIG. 2 is a schematic of a method of creating a historical record of the use of a permission.

### DETAILED DESCRIPTION

A Permissions Management Platform (PMP) which tracks and exposes the origination, circumstances and history of permissions between parties has been developed that provides an ideal solution to the issues discussed earlier and provides substantial utility to consumers and Consumer Email Providers or CEPs. By exposing the activities and relationships which result in messaging, a PMP records and makes available the information most relevant for determining whether any particular message is wanted by the recipient or will be considered SPAM. CEPs would be able to determine the appropriate handling of a message based on the specific message, rather than inferred information derived from profiling, bounce and complaint ratios, and other statistical methods. Consumers would be able to view the permissions they have issued to third parties, and modify or revoke such permissions. A PMP also provides CEPs with additional information by which to measure the legitimacy and quality of messaging in bulk (e.g. from a particular Publisher or Advertiser), which may be incorporated into its profiling methods, filtering activities, and whitelisting programs. Finally, a PMP provides CEPs with additional tools, beyond a “this is spam” button, with which to empower its users and increases customer satisfaction.

Specifically, a permissions management platform is disclosed that includes: a documentation agent, which documents and tracks at least one circumstance, wherein the at least one circumstance comprises at least one permission that is provided from at least one first party to at least one second party; and at least one authorized party, wherein the at least one authorized party has access to the documentation agent. As mentioned, the at least one authorized party has access to the documentation agent, whether the access is in the form of a consistent electronic stream of information or whether the access in upon or after the initiation, change or revocation of the at least one permission.

A software system is also disclosed that includes the permissions management platform disclosed herein stored on a recordable medium. Methods for documenting and managing permissions information are described that include: providing a documentation agent that documents the circumstances in which permission is provided from at least one first party to at least one second party; creating a documentation record; storing the documentation record in a retrievable format; and providing at least one authorized party having access to the documentation record.

In contemplated embodiments, a documentation agent is a functioning observer of the circumstances of a permission grant; a documentation record is the document or information that is produced as a result of the documentation agent's observation. The documentation record is what gets stored, and is made available for access and retrieval. In a contemplated embodiment, a documentation agent, observes and records events at any place where a permission is granted, modified/revoked, retrieved, or used (relied upon in order to take some action, such as sending a message).

Contemplated embodiments include apparatus, systems and methods in which the origination and modification of permissions between two or more parties are observed, documented and catalogued in a retrievable format by a third party. The issuance of a permission between the parties are recorded, along with the relevant circumstances and contextual information of such issuance, which will be referred to herein as a “circumstance”. For example, when a consumer subscribes to a newsletter or registers at a website, the system may record at least one circumstance that includes the date and time, the consumer's IP address, the website's IP address, the software used to view such website, the text and images present on such website, the website's privacy policy and terms and conditions of use, the information submitted by the consumer, and any other recordable information deemed relevant to the permission granted.

Some contemplated embodiments are shown within the context permissions obtained and used for the purpose of email messaging, but should be considered generic to all types of permissions issued, and all types of electronic messaging, and particularly important for email, text messaging, instant messaging, other forms of messaging. It is also contemplated that the disclosed techniques can be applied to content delivery.

Contemplated embodiments include a PMP which is incorporated into the consumer's web browser, which records the consumer's relevant activities, and ultimately circumstances, online. The PMP may retain such recorded information solely on the consumer's local computer for privacy reasons, or return such data to a primary server for disclosure to authorized users. The return of such data may occur in real time, as such information is recorded, or in asynchronous batch processes.

In another contemplated embodiment, the PMP may be incorporated into the website of an advertiser or other product or service provider. Similarly, the recorded information may be retained locally with the website, or relayed to a primary server for the purpose of facilitating storage and retrieval of such permissions information.

In a contemplated embodiment, recorded permissions information (circumstances) is made available to the parties to such permission and their authorized representatives. The party providing the permission also has the ability to modify the terms and validity of such permission. The retrieval and modification of a permission may be performed manually (e.g. through a web browser) or on an automated based (e.g. through an authenticated API). Permissions may be grouped by certain business rules, or by the identity of the party retrieving such information (e.g. a CEP automatically retrieves all recorded permissions related to its customers, an individual retrieves all recorded permissions such individual has provided to any third party, and an advertiser retrieves all permissions granted to it by consumers).

Permissions may also be coded for use as metadata authenticating the basis of any use of or reliance on such permission (e.g. the authentication of messaging). For example, a publisher may tag each message sent with a permission code, which enables the receiving CEP to independently authenticate the existence and validity of the permission authorizing such message. Such message tagging enables the CEP to better manage and enforce the handling of messaging for its customers.

In a contemplated embodiment, the PMP processes new permissions data, or modifications to existing permissions data, in real time. A contemplated PMP may also include establishing configurable rules defined by a CEP, for use in determining the appropriate handling of messages based on such rules and the current permissions information recorded by the PMP. The PMP may also provide senders with a method to tag outbound messages based on the relevant permissions in order to facilitate or comply with CEP policies. For example, a permission may allow no more than three messages delivered per week. A sender may code each message sent with the relevant permission, along with whether such message is the first, second or third message sent during a given week, in order to facilitate message handling by the recipient CEP and/or comply with such CEP's message handling policies. Similarly, a CEP may report to the PMP information on each message received and request direction on how each particular message should be handled; in this case, the PMP would authorize delivery of the third message sent during the week, but advise the CEP to discard a fourth message send during the same week.

One can also consider contemplated embodiments as policy enforcement agents, which as part of their enforcement have control over message delivery. The disclosed techniques can be equally applied to generic data sources of any type, whether obtained through a CEP, through consumer tool bars, or other sources.

It is also contemplated that content could be tailored or modified according a delivery policy which relies in part on permissions information, which is another type of “policy engine” that makes use of external data to provide a customized experience for a consumer through messaging or through a content delivery system. Content providers by default must present a “one size fits all” version of content on their website regardless of viewer demographics. A content presentation engine that takes input from external sources to determine which content to present, and how to customize such content, provides a powerful mechanism for more intelligent marketing.

Ideal embodiments can provide consumers and vendors with relationship continuity services which are difficult to obtain in the current art. For example, a consumer who changes her email address typically must notify every vendor and other relationship which utilizes her old address of the updated address. A permissions platform which maintains records on each relationship maintained by such consumer can enable a simple method for automatically notifying each party with a relationship with such consumer of the consumer's new address, and modify the permission records accordingly. Similarly, a consumer might designate that all messages be suspended for a certain period of time while he is on vacation, and that certain types of messages, such as advertising content be discarded entirely during such vacation period.

In another embodiment, the permissions management platform may enable consumers to effectively manage multiple channels of communication, each for a specific purpose. A consumer might maintain multiple addresses, each designated for a specific relationship or for a particular type of use or messaging content, and such criteria might be a condition for use of any issued permission. For example, a consumer may designate one email address for transaction content, such as purchase receipts, and another email address for marketing offers, such as coupons or sale notifications, and a third address for newsletters and subscription messages.

### EXAMPLES

### Example 1

### EvenTrust Email-Communication Example

For lack of a better term at present, “two people” can represent two individuals, a single individual and a group of people running a website, or two groups of people running two different websites (where a “group of people” corresponds to on one of the parties in the “two people” phrase).

Generally speaking, all communication between “two people” in this system is forbidden (completely restricted) unless a specific agreement (“Trust”) is created and agreed upon between the “two people”. This Trust is then equally revocable at any point after the Trust has come into existence. This Trust can be applied to various “mediums” of communication (email and instant messaging), as well as monetary transactions for online payment between “two people”. Further, the Trust can optionally define various sub-contexts in which a communication may occur (such as: (1) a vendor sending a person online coupons, (2) a vendor communicating with a person in a “help desk support” role, (3) a vendor sending a person monthly newsletters). Participants in the trust can request to have a Trust only apply to certain mediums and sub-contexts.

User has an EvenTrust email address and visits a new website:
1. A person (“User”) browsing the Internet visits a webpage (“Vendorsite”). The Vendorsite has a webpage that contains a web form with a text field that asks for the User's email address.
2. The User enters their email address (user@eventrust.com) into the text field.
3. The User submits the web form to the Vendorsite.
4. The computer (“Vendorserver”) that hosts the Vendorsite receives the request and determines that the specified email address has not been submitted to the site before.
5. The Vendorserver checks a DNS TXT record for a special domain, such as “_eventrust.eventrust.com” (the word “_eventrust”, joined with a period to the original domain, eventrust.com from “user@eventrust.com”), which is an indication that the address is “protected by EvenTrust” and requires permission to send emails to it. Note that if Vendorserver already knows that the email address is “protected by EvenTrust”, then this step can be skipped.
6. The Vendorserver has determined that the email address is “protected by EvenTrust” so the Vendorserver must proceed to guide User to the following steps.
7. The Vendorserver optionally: (1) shows User a page with a button indicating that when User clicks on it, they will be redirected to the eventrust.com website, or (2) immediately redirects User to the eventrust.com website's login page.
8. When Vendorserver redirects User to the web page, Vendorserver also sends accompanying information, including: (1) credentials identifying Vendorsite as the sender, (2) User's specified email address that was submitted to Vendorsite, (3) a context (i.e. “support forums”) in which this trust is being setup, (4) any return URLs for redirecting back to Vendorite upon acceptance, rejection, or cancellation of the following steps (see below). This data may optionally be encrypted to authenticate that the message is from Vendorsite, and to ensure that only Vendorserver and the servers at EvenTrust (“EvenTrustserver”) can read the message.
9. User logs into the EvenTrust website (“EvenTrustsite”) specifying the password that corresponds to the earlier-specified email address.
10. EvenTrustsite determines if Vendorsite has any requirements to create a Trust (A Trust is the actual system representation of an agreement to allow email to be sent between “two people”). Examples of requirements include: (1) User must “post a bond” to create a Trust, (2) User must have certified information within the EvenTrust system (i.e. user must have verified to EvenTrustservice that they live at a known address, have a known phone number, be a certain age, etc.). Here, “Post a bond” means that the requester (User) could be required to present an amount of money (i.e. $1.00) to the requestee (Vendorsite). For posted bonds, the amount ($1.00) is removed from the requestor's EvenTrust account and “held in escrow” by the EvenTrust system; the requestee would have the option to accept, decline, or ignore the bond. Accepted bonds would have the escrowed bond credited to the requestee's account; declined bonds would have the escrowed bond credited back to the requestor's account; an ignored bond would stay in escrow until the requestee canceled or declined the bond, or until the escrowed bond expired (at which point the escrowed bond would be credited back to the requestor).
11. If User meets all requirements (described in previous step) by Vendorsite, User is shown a page indicating that User is requesting a Trust with Vendorsite, so that User and Vendorsite can send and receive emails between each other. (I.e. once the Trust exists, User would send/receive from his user@eventrust.com address. If Vendorsite is a person, then they will send/receive email using the one email address that is protected by EvenTrust. If Vendorsite is a website (group of people), then there may be several addresses that are associated with Vendorsite that can be used to send/receive email to User, such as: vendorsite.com@eventrust.com, support.vendorsite.com@eventrust.com).
12. If “context” information has been specified by Vendorsite, then the User is shown this information as part of the Trust that will be created. The “context” provides additional focus about how Vendorsite will communicate to User. A context might be “support forums”, or “monthly newsletters”, or “daily coupons”. (User would have the option to choose only specific contexts for the trust).
13. User specifies the “communications medium” of the Trust. In this case, the “medium” is email (alternatively, the user could specify email and/or instant messaging (if Vendorsite has setup instant messaging in EvenTrust)).
14. User confirms the new Trust. (User might optionally specify a brief introductory message to be sent with the request. This would be configurable on the confirmation page).
15. If Vendorsite requires a bond to be posted, then the amount of the bond is removed from the User's account and placed into escrow in the EvenTrust system.
16. EvenTrustserver records in its system that a “pending trust” has been created between User and Vendorsite (requested by User).
17. EvenTrustserver redirects the user back to the Vendorsite. The destination web page may have been specified during the payload of data that came from Vendorsite to EvenTrustsite, or may have been specified by Vendorsite earlier in the EvenTrustserver via interactions with EvenTrustsite.
18. If Vendorsite accepts the request, EvenTrustserver records in its system that there is now a “trust” between these “two people”. Note that Vendorsite may automatically accept any requested Trust from a requester that meets its requirements.
19. If Vendorsite declines the request, EvenTrustserver cancels the pending Trust (and notifies the User that the trust was declined).
20. If Vendorsite accepts the posted bond (if one was posted), the bond is removed from escrow and credited to Vendorsite's EvenTrust account.
21. If Vendorsite declines the posted bond (if one was posted), the bond is removed from escrow and credited to User's EvenTrust account.
22. if Vendorsite ignores the posted bond (if one was posted), the bond remains in escrow until: (1) Vendorsite accepts the bond, (2) Vendorsite declines the bond, (3) the bond expires (at which time the expired bond will be removed from escrow and credited back to User's EvenTrust account).
   [The following steps assume that Vendorsite and User have an accepted trust]
23. Upon acceptance of the trust by Vendorsite, EvenTrustsite notifies Vendorsite and User the new Trust, including each other's email “EvenTrust-protected” addresses that the Vendorsite and User can use to send email to each other.
   This scenario assumes that a user visiting the same Vendorsite does not yet have an EvenTrust address.

Assuming a trust now exists between User and Vendorsite, User and Vendorsite can now send emails to each other using their “EvenTrust-protected” addresses:
1. Vendorsite sends an email from their email address (support@vendorsite.com) to User (user@eventrust.com).
2. Vendorserver initiates an SMTP conversation to EvenTrustserver.
3. Vendorserver tells EvenTrustserver that an email is coming from support@vendorsite.com.
4. EvenTrustserver confirms that support@vendorsite.com is allowed to send email to recipients in the system.
5. EvenTrustserver verifies via DNS SPF (Sender Policy Framework) records that email from support@vendorsite.com can be sent by Vendorserver.
6. EvenTrustserver acknowledges during the SMTP conversation that support@vendorsite can send an email to it.
7. Vendorserver tells EvenTrustserver that it wants to send an email to user@eventrust.com.
8. EvenTrustserver confirms that a Trust exists between the account corresponding to support vendorsite.com and user@eventrust.com.
9. EvenTrustserver acknowledges during the SMTP conversation that the user@eventrust.com recipient is ok.
10. Vendorserver transmits the email message (header, body, attachments) to EvenTrustserver.
11. EvenTrustserver acknowledges the email has been received.
12. If the User has a hosted email account with in the EvenTrustserver, then the email is stored into the User's email account, and optionally forwarded (as described in the following steps).
13. If the email is to be forwarded to the User's alternate private email address (such as user@gmail.com), then the following steps take place.
14. EvenTrustserver changes the email:
   a. All transit-related email headers are removed from the email (such as “From”, “To”, “Sender”, “Received”, etc.)
   b. New headers are put into the email, indicating that the email originated from the EvenTrustserver, including:
      i. From: support.vendorsite.com@eventrust.com
      ii. To: user@eventrust.com
      iii. Reply-to:
         support.vendorsite.com@eventrust.abcdefg1234567.auth.eventrust.com
         (Note that the “bacdefg1234567” is an example code to be used and not the specific code that would be used for any implementation.)
15. EvenTrustserver forwards the new email to the User's alternate private email address.
16. User replies to the email from his alternate private email address. The reply email will be addressed:
a. From: user@gmail.com
b. To: support.vendorsite.com@eventrust.abcdefg1234567.reply.eventrust.com
17. EvenTrustserver receives the email from the mailserver of the User's private email address.
18. If Vendorsite has a hosted email account with EvenTrust, then the email is stored in the Vendorsite's hosted email account, and optionally forwarded (as described in the following steps).
19. If to be forwarded, EvenTrust removes all transit-related headers, and changes the headers to:
   a. From: user@eventrust.com
   b. To: support.vendorsite.com@eventrust.com
   c. Reply-to: user@eventrust.mnopqrstuvw6789012.auth.eventrust.com
20. EvenTrustserver forwards the email to the Vendorsite at support@vendorsite.com.
21. The people who use the support@vendorsite.com address could then reply in the same manner (described above).
   Non-user comes to EvenTrust-supported site:
1. User comes to a site (Vendorsite) that asks for an email address.
2. Vendorsite displays a form that indicates that EvenTrust is accepted/supported. This form is created by the person who manages the code on the web page, by placing HTML code provided by the EvenTrust service. This code would render (either via direct HTML insertion or by JavaScript) a logo and a “click here for more info” button. This implantation of code or JavaScript is commonly referred to as implantation of a “widget” (commonly installed on blogs, MySpace, and similar websites).
3. User clicks on “more info” button.
4. Vendorsite redirects to EvenTrustsite, indicating
5. Vendorsite shows a pop-up dialog explaining what EvenTrust is, and provides a link to the EvenTrust website to create a free account.
6. User clicks on the link to go to the EvenTrust site.
7. EvenTrust site shows user a “create new account” page.
8. User enters their private email address (i.e. user@gmail.com) and a new password, then submits the form.
9. EvenTrustserver sends User a confirmation email.
10. User clicks on link in confirmation email.
11. User is shown page saying “account confirmed”, and a button options:
   a. Do you want to create a new trust with Vendorsite? (click to confirm)
   b. Button to click saying “return to Vendorsite” to continue.
12. If User clicks “create Trust”, User is shown a confirmation page of the new Trust and is shown a button to click on to return to Vendorsite.
13. If User clicks on “Return to Vendorsite”, then the user is returned to the original Vendorsite page, where they first saw the form asking for their email address.

### Payments:

Once relationships have been established between “two people”, the “two people” may want to transact a payment. The EvenTrust system would be used to issue invoices, and from one “person” to another “person”.
1. User visits Vendorsite.
2. Vendorsite offers goods and/or services for sale.
3. User indicates they want to purchase one or more goods or services (using a common mechanism such as a shopping cart).
4. User indicates that he now wants to finish his purchase (to “check-out”).
5. Vendorsite shows the check-out page, which provides a payment option of “Pay via EvenTrust”.
6. User indicates on web form on web page they would like to pay using EvenTrust, and clicks the “Continue” button.
7. Vendorsite redirects the user to EvenTrustsite. Vendorsite also passes information to EvenTrustsite, indicating the items and/or the amount to be paid for the goods. Vendorsite can also specify additional information to be collected from User by EvenTrust (such as a billing address, phone number, etc.) This information may optionally be encrypted.
8. EvenTrustsite prompts user to login (provide EvenTrust username & password).
9. User logs-in.
10. EvenTrustsite shows user that Vendorsite wants the User to pay the amount for the specified goods (and optionally provide additional information, such as
11. User selects a method of payment (EvenTrust account-debit, credit card charge, direct bank debit, optionally adding a new payment method, such as a new credit card).
12. User confirms to pay the amount by clicking a button on the page using the specified payment method. Note that this payment may optionally be a repeating payment.
13. EvenTrustsite notifies Vendorsite that the payment has been received.
14. EvenTrustsite shows a page to the User, confirming the transaction has occurred, and includes a button for User to click to return to Vendorsite.
15. User clicks on button to return to Vendorsite.
16. EvenTrust redirects user to Vendorsite's “thanks” page. Optionally, EvenTrustsite may send Vendorsite confirmation about the transaction as hidden transaction information.
17. Vendorsite checks that the transaction has actually occurred.
18. Vendorsite shows user page saying “Thanks for your purchase”.
   Masking of payment method change:
1. User sets-up a recurring payment with Vendorsite.
2. Time passes such that User's current payment method will expire soon (i.e. credit card will expire soon).
3. EvenTrustsite notifies User that the payment method will expire soon.
4. User logs-in to EvenTrust site.
5. User updates their credit card information (or specifies a different payment method altogether) using EvenTrustsite.
6. Vendorsite gets paid as usual (never knows or worries about expiring payment methods; never has to setup a mechanism to monitor and remind the user that their payment method is expiring).

### Instant Messaging Control:

When two users request and accept a Trust between each other, this known relationship can then be used to similarly govern unsolicited instant messages:
1. User “Joe” visit “Mary's” blog web page and indicates that she has an Instant Messaging nickname “mary@eventrust.com”.
2. Joe follows the same steps for setting-up a Trust (as described above for email) between his ID (joe@eventrust.com) and Mary's ID, (Steps from above include: getting redirected to EvenTrust, logging-in, showing the requested Trust, confirming the Trust, posting a bond if needed, getting shown a confirmation. If needed to create a new EvenTrust account, he could follow the same steps for the new-account scenario described earlier).
3. When Joe gets to the step for confirming the Trust, he specifies the “medium” as “Instant Messaging” instead of email (or in addition to email).
4. After confirming the request for the Trust, Joe is redirected back to Mary's original page on her blog.
5. Once Mary accepts the Trust, Joe and Mary can unrestrictedly send instant messages to each other. They would use an IM client that is hosted on the web pages of the EvenTrustsite, an IM client plugin for a browser (such as a Firefox browser extension), or a stand-alone IM client application specific for EvenTrust.
6. Alternatively, existing non-EvenTrust IM clients can be adapted to query the EvenTrust system via a public API to determine what users are permitted to to send instant messages to a user.

### Certified Information:

As mentioned earlier, the EvenTrust system would allow requestees to require “certified” information about a Trust requester. The EvenTrust system would provide some of these services, but would also allow for any individual or company to register as a “credential service” with EvenTrust. Requestees would require verification by a “credential service”. Such a credential service would provide verification of one or many things about an EvenTrust participant, including:
1. Age (specific, or range-based such as “18 or older”).
2. Address (just that they have an actual address, or that it is a specific address, or that they live in a specific city, state, or country).
3. Credit card (that they have a credit card, or a certain type of card).
4. Credit rating (must be above a certain level).
   EvenTrust participants would apply for certification with any provider for the specific certification that they need. The credential service provider may require a fee to provide the certification. Not all requestees may accept certifications from all credential service providers (This would result in a mini-market of competition for credential-providers.) All credential service providers would be subject to approval and review by EvenTrust.

### Example 2

### Management of Permission Records

The following example shows a contemplated embodiment within the context of an example permissions platform which documents permissions records and provides such records to various users. In the presented examples, two consumers provide a permission via two different websites, and the records associated with such permissions are used by a CEP, an advertiser, a publisher, and a consumer granting such permission.

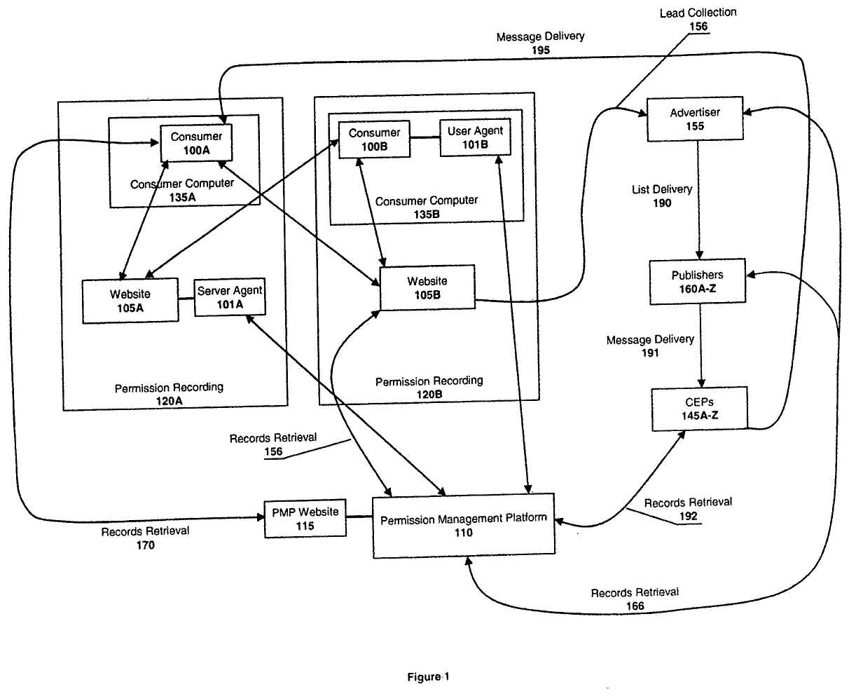

In FIG. 1, website 105A incorporates Server Agent 101A of permission management platform 110 for the purpose of monitoring and recording permissions by consumers granted by one or more consumers 100A through 100B. Consumer 100A accesses website 105A and provides permission to receive certain types of messaging, and Server Agent 101A records the circumstances of such permissions 120A and communicates all documents generated as a result of such permission to permission management platform 110 for storage and retrieval by authorized parties.

In a contemplated embodiment, consumer 100A is authorized to view any permission records associated with his own permissions, and may retrieve such records 170 at PMP website 115. As PMP website is an aggregation point for all permission records documents, consumer 100A may view all his permission documents stored and managed by permission management platform 110 at PMP website 115. Consumer 100A may also modify the terms of his permission records, or revoke such permissions, at PMP website 115.

The permission recording environment 120B represents an alternate scenario. In this scenario, website 105B resides does not incorporate a server agent. However, consumer 100B has installed on her computer 135B a user agent 101B for the purpose of documenting any permissions granted by consumer 100B at one or more websites 105A through 105B. Performing a similar function to server agent 101A, user agent 101B records the circumstances of any permissions 120B granted by consumer 100B and communicates all documents generated as a result of such permissions to permission management platform 110 for storage and retrieval by authorized parties.

In this example, in the event consumer 100A grants a permission at website 105B, there is no agent present to document such permission. However, in another preferred embodiment, permission management platform 110 may have permissions information pertaining to consumer 100A based on other permissions granted by consumer 100A or permission information provided by consumer 100A directly via PMP website 115. In the event website 105B is authorized to access such permissions records, website 105B may tailor the content presented to consumer 100A based on such permissions records.

Advertiser 155 collects consumer sales lead information 156 from its website 105B. Advertiser 155 provides a list 190 of consumer information to one or more publishers 160A-Z, who are responsible for promoting the goods and services of advertiser 155 to such consumers. Advertiser 155 may retrieve permissions records 166 from permission management platform 110 in order to authenticate the list of consumers provided to publishers 160A-Z. In addition, advertiser 155 and publishers 160A-Z may retrieve records 166 from permission management platform 110 for the purpose of creating more targeted and effective marketing content to deliver to such consumers.

Publishers 160A-Z send the resulting messages to one or more CEPs 145A-Z, and in an ideal environment includes metadata for each message identifying the advertiser 155, the publisher 160, the permission record which resulted in the message, or some combination of these.

Each CEP 145A-Z is responsible for delivering such messaging to its customers, and desires to determine whether such messages are legitimate and the result of valid permissions provided by their customers. A CEP 145A-Z obtains the records 192 from permission management platform 110 associated with its customers, and associated with the metadata included with each message received. The CEP uses such information, along with its other policies and business processes, to determine the disposition and handling of each message.

Consumers, advertisers, publishers, CEPs, and other parties may also access permission management platform 110, in order to obtain aggregate profile information on another party for the purpose of evaluating the business practices and reputation of such party.

In this embodiment, permission management platform 110 records each retrieval and use of a permission record for the purpose of maintaining a history of the how a permission has been utilized. In addition, the permission management platform allows authorized users to modify the terms and validity of issued permissions.

### Example 3

### Creation of Historical Record of Use of Permissions

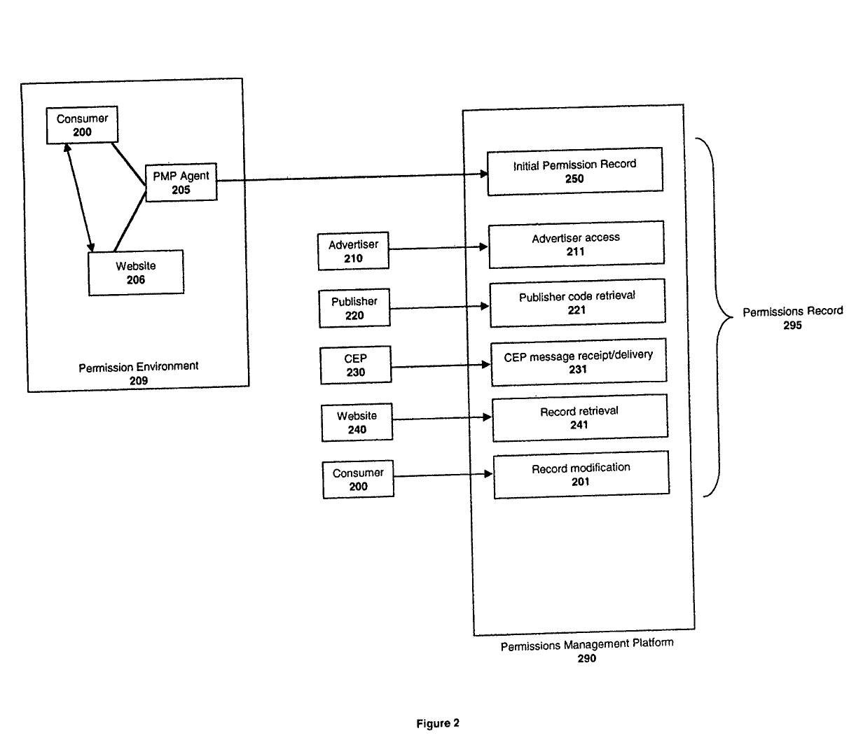

In FIG. 2, permissions management platform agent 205, which may reside on the computer of consumer 200, be incorporated into website 206, or reside on a third party system which observes the permission environment 209, delivers the initial permission record 250 to permissions management platform 290.

Advertiser 210 accesses the permissions record 295, and the permissions management platform 290 records the advertiser access 211. Similarly, publisher 220, CEP 230, website 240 and consumer 200 obtain the permission record 295, and the permission 295 is updated with a record of each respective request and in the ideal embodiment, documentation of the nature of the request and use of the permission record.

For example, CEP 230 may request the permission record 295 for the purpose of authenticating a message to consumer 200 from publisher 220 based on a permission granted to advertiser 210 at website 240. Upon obtaining confirmation of the validity of the message based on permission record 295, CEP 230 may advise permissions management platform 290 that it will deliver such message to consumer 200. Permissions management platform 290 records as CEP message receipt/delivery 231 the access of permissions record 295 by CEP 231, the purpose of such access, and the delivery of the message in question.

Thus, specific embodiments and applications of permission management platforms have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A permissions management platform, comprising:
a documentation agent, which documents at least one circumstance, wherein the at least one circumstance comprises at least one permission that is provided from at least one first party to at least one second party, and
at least one authorized party, wherein the at least one party has access to the documentation agent.

2. The permissions management platform of claim 1, wherein the platform is incorporated into a user's web browser.

3. The permissions management platform of claim 1, wherein the platform is incorporated into the website of an advertiser or a service provider.

4. The permissions management platform of claim 1, wherein the at least one first party and the at least one second party comprise at least one consumer.

5. A software system, comprising the permissions management platform of claim 1 stored on a recordable medium.

6. The software system of claim 5, wherein the recordable medium comprises a server, a hard drive, a compact disc, a flash drive or a combination thereof.

7. A method for documenting and managing permissions information, comprising:
providing a documentation agent that documents the circumstances in which permission is provided from at least one first party to at least one second party;
creating a documentation record; storing the documentation record in a retrievable format;
and providing at least one authorized party having access to the documentation record.

8. The method of claim 7, wherein the documentation agent may be amended, revoked or a combination thereof.

9. The method of claim 8, wherein the method further comprising storing the amendments, revocations or a combination thereof.

10. The method of claim 7, wherein the documentation agent documents, monitors, records or a combination thereof the use of a permission.

11. The method of claim 7, wherein the at least one first party and the at least one second party comprises at least one consumer.
